(19) United States
(12) Patent Application Publication
(10) Pub. No.: US 2021/0371347 A1
(43) Pub. Date: Dec. 2, 2021

(54) Composition Having Plasma-treated Silicon Carbide, Ultra-High Molecular Weight Polyethylene and Carbon Nanotube Fibers

(71) Applicant: Integrated Composite Construction Systems, LLC, Culpepper, VA (US)

(72) Inventor: Douglas Darling, Culpepper, VA (US)

(21) Appl. No.: 17/334,609

(22) Filed: May 28, 2021

Related U.S. Application Data
(60) Provisional application No. 63/031,330, filed on May 28, 2020.

(51) Int. Cl. C04B 40/00; C04B 28/04; C04B 14/32; C04B 16/06; C04B 14/02; C04B 14/06; C04B 18/14; C04B 14/08; C04B 14/48; C04B 18/24; C04B 20/04; C04B 20/10

(52) U.S. Cl. CPC C04B 40/0032; C04B 28/04; C04B 14/324; C04B 16/0625; C04B 14/026; C04B 14/06; C04B 2111/00612; C04B 14/08; C04B 14/48; C04B 18/24; C04B 40/0042; C04B 20/04; C04B 20/1074; C04B 18/146

(57) ABSTRACT

The invention relates to processes for making improved ultra-high performance concrete with plasma-treated inclusions and articles made from the same. The invention includes a process for producing silicon carbide and multiwalled carbon nanotubes by heating agricultural waste husks in an inert atmosphere to a temperature higher than 1300 degrees C. to obtain a mixture containing silicon carbide and MWCNTs, and treating the mixture to extract the silicon carbide and MWCNTs for use as microinclusions in ultra high performance concrete.

### BACKGROUND OF THE INVENTION

### Field of the Invention

The invention relates to processes for making improved ultra-high performance concrete with plasma-treated inclusions and articles made from the same.

### Description of the Related Art

Durable construction materials come in many forms. However, there is still a need for improved compositions having properties desirable in construction projects.

### SUMMARY OF THE INVENTION

Accordingly, the invention provides compositions and processes for making such compositions that are useful in manufacturing ultra high performance concrete by mixing microinclusions into a dry mixture of first constituents to yield a first homogeneous mix, the microinclusions selected from the group consisting of silicon carbide, ultra-high molecular weight polyethylene fibers, and multi-walled carbon nanotubes, the first constituents, comprising: cement of Blaine fineness of about 280 to about 360 m2/kg; sand, wherein said sand is provided at a mass ratio of about 0.75 to about 1.25 of said cement; silica fume, wherein said silica fume is provided at a mass ratio of about 0.15 to about 0.4 of said cement; silica flour, wherein said silica flour is provided at a mass ratio of about 0.15 to about 0.3 of said cement; wherein said microinclusions are provided at a mass ratio of up to about 0.35 of said cement.

In preferred embodiments, the microinclusions are plasma-treated before mixing into the dry mixture of first constituents.

In other preferred embodiments, the silicon carbide and the multiwalled carbon nanotubes are obtained by heating agricultural waste husks in an inert atmosphere to a temperature higher than 1300 degrees C. to obtain a mixture containing silicon carbide and MWCNTs, which may optionally be separated before plasma treatment and use as microinclusions.

In other preferred embodiment, plasma-treated steel microfibers are to the dry mixture of first constituents.

In another preferred embodiment, the invention provides ultra high performance cement paste and processes for making such ultra high performance cement paste by (ii) adding second constituents to the first homogeneous mix, said second constituents comprising at least one high-range water-reducing admixture; and water, wherein said water is provided at a mass ratio of about 0.2 to about 0.35 of said cement, and wherein said high-range water-reducing admixture and said water are blended into a second homogenous mix prior to mixing said second homogenous mix with said first homogeneous mix to form a uniform cement-containing paste.

In other preferred embodiments, the plasma treatment comprises: (i) plasma cleaning to remove organic contamination, remove surface oxides, increase surface hydrophilic property, and improve adhesion, wherein the plasma treatment is selected from the group consisting of: Argon plasma micro-sandblasting, Hydrogen plasma treatment for removal of surface oxides on the recycled steel fibers, Helium plasma treatment, Nitrogen plasma treatment, and Oxygen plasma treatment; or (ii) plasma surface-modification by plasma enhanced chemical vapor deposition to coat the microinclusions with one or more layers selected from the group consisting of: carbon, silicon, carbon nanotubes, silicon carbide, silicon nitride, and mixtures thereof; and/or (iii) plasma surface energy modification to create one or more ultra-thin layers of a film that adjusts wetting properties to improve of the wettability and increase the mixability of the microinclusions in the composition.

The cement-containing paste is used to manufacture components are selected from the group consisting of: plates, channels, pipes, tubes, I-sections, WF-sections, connectors, panels, and combinations thereof.

Components made using the compositions herein are also employed to fabricate items selected from the group consisting of: vehicle up-armoring, ballistic armor, blast-resistant panels, man-portable panels, thin armor panels, forced entry resistant structural elements, roofing tiles, wall panels, floor tiles, hurricane and tornado resistant structural elements, and combinations thereof.

The compositions may also be cured to achieve enhanced strength by (i) placing in an environment of approximately 100% relative humidity for about seven days at ambient temperature, (ii) submersing in water of approximately 85° C. to about 91° C. for about three to about five days, and (iii) heating in air at approximately 85° C. to about 91° C. for about one to about two days, wherein, said cured composition component becomes crystalline unlike said composition components cured under ambient conditions as an amorphous calcium silicate hydrate.

In another preferred embodiment of the invention, there is provided a ultra high performance component, comprising: a form made using the composition(s) described herein, wherein the component has a strength of at least 10,000 psi, or has a strength of over 21,500 psi, or is heat cured and has a strength of over 100,000 psi.

### BRIEF DESCRIPTION OF THE FIGS

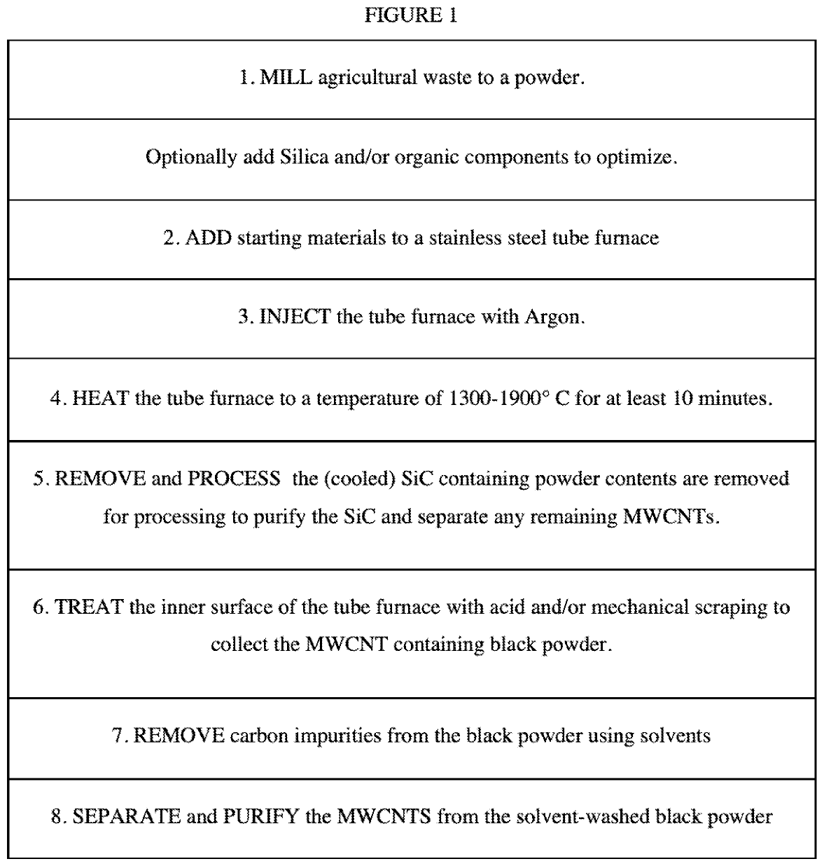

FIG. 1 shows a process flowchart illustrating one preferred process of this present invention. FIG. 1 shows milling the agricultural waste to a powder, with any added silica and/or organic components. Heating the starting materials. And purifying the SiC and the MWCNTs.

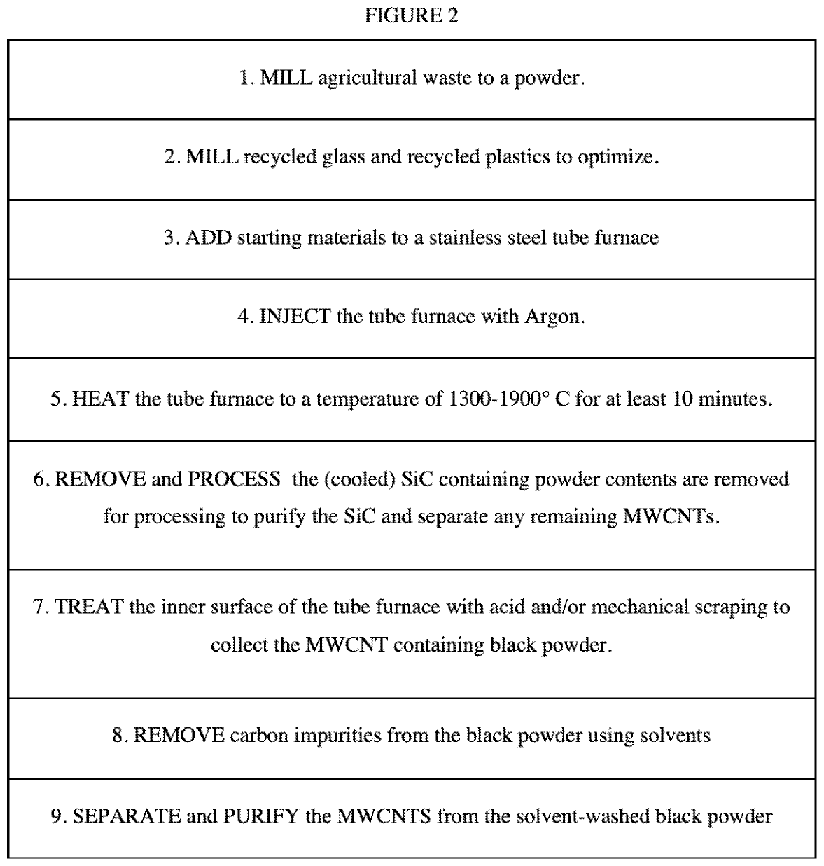

FIG. 2 is a process flowchart of another preferred process, using recycled plastic and recycled glass. FIG. 2 shows milling the agricultural waste to a powder, with any added silica and/or organic components. Heating the starting materials. And purifying the SiC and the MWCNTs.

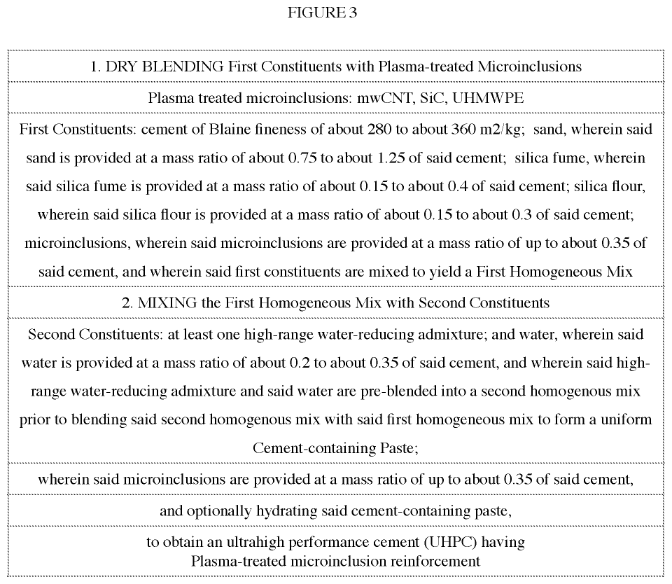

FIG. 3 is a process flowchart illustrating the use of microinclusions (SiC and MWCNTs) in Ultra High Performance Concrete. FIG. 3 shows blending a cement mixture with fibers containing SiC and/or MWCNTs to obtain reinforced ultra-high performance concrete (UHPC). Surprisingly, it has been found that it is important for the microinclusions to be dry-blended with the first constituents to ensure the proper dispersion of the microinclusions within the resultant composition and to obtain homogeneity of the mixed components.

### DETAILED DESCRIPTION

Disclosed herein are embodiments directed to compositions and processes for making such compositions that are useful in manufacturing ultra high performance concrete by mixing microinclusions into a dry mixture of first constituents to yield a first homogeneous mix, the microinclusions selected from the group consisting of silicon carbide, ultra-high molecular weight polyethylene fibers, and multi-walled carbon nanotubes, the first constituents, comprising: cement of Blaine fineness of about 280 to about 360 m2/kg; sand, wherein said sand is provided at a mass ratio of about 0.75 to about 1.25 of said cement; silica fume, wherein said silica fume is provided at a mass ratio of about 0.15 to about 0.4 of said cement; silica flour, wherein said silica flour is provided at a mass ratio of about 0.15 to about 0.3 of said cement; wherein said microinclusions are provided at a mass ratio of up to about 0.35 of said cement.

Also disclosed herein are embodiments directed to ultra high performance cement (UHPC) paste and processes for making UHPC paste comprising:

(i) mixing microinclusions into a dry mixture of first constituents to yield a first homogeneous mix, the microinclusions selected from the group consisting of silicon carbide, ultra-high molecular weight polyethylene fibers, and multi-walled carbon nanotubes, the first constituents, comprising: cement of Blaine fineness of about 280 to about 360 m2/kg; sand, wherein said sand is provided at a mass ratio of about 0.75 to about 1.25 of said cement; silica fume, wherein said silica fume is provided at a mass ratio of about 0.15 to about 0.4 of said cement; silica flour, wherein said silica flour is provided at a mass ratio of about 0.15 to about 0.3 of said cement; wherein said microinclusions are provided at a mass ratio of up to about 0.35 of said cement, and

(ii) adding second constituents to the first homogeneous mix, said second constituents comprising at least one high-range water-reducing admixture; and water, wherein said water is provided at a mass ratio of about 0.2 to about 0.35 of said cement, and wherein said high-range water-reducing admixture and said water are blended into a second homogenous mix prior to mixing said second homogenous mix with said first homogeneous mix to form a uniform cement-containing paste.

In another preferred embodiments, the microinclusions are plasma-treated before mixing.

In another preferred embodiment, the silicon carbide and the multiwalled carbon nanotubes are obtained by heating agricultural waste husks in an inert atmosphere to a temperature higher than 1300 degrees C. to obtain a mixture containing silicon carbide and MWCNTs.

In another embodiment, the mixture containing silicon carbide and MWCNTs is treated to extract MWCNTs and separate the MWCNTs from the silicon carbide, and wherein the plasma treatment of the MWCNTs is separate from the plasma treatment of the silicon carbide.

In another preferred embodiment, plasma-treated steel microfibers are added to the dry mixture of first constituents.

Any of the embodiments herein may include wherein the plasma treatment of the microinclusions comprises plasma cleaning, plasma surface-modification, or plasma surface-energy modification.

Plasma cleaning comprises removal of organic contamination and surface oxides, increase of surface hydrophilic property, and improvement of adhesion, wherein the plasma treatment is selected from the group consisting of: Argon plasma micro-sandblasting, Hydrogen plasma treatment for removal of surface oxides on the recycled steel fibers, Helium plasma treatment, Nitrogen plasma treatment, and Oxygen plasma treatment.

Plasma surface-modification uses plasma enhanced chemical vapor deposition to coat the microinclusions with one or more layers selected from the group consisting of: carbon, silicon, carbon nanotubes, silicon carbide, silicon nitride, and mixtures thereof

Plasma surface energy modification creates one or more ultra-thin layers of a film that adjusts wetting properties to improve the wettability and increase the mixability of the microinclusions in the composition.

Any of the embodiments herein may include additional microinclusions are selected from the group consisting of: metals, alloys, steel, synthetics, polymers, natural inorganics, minerals, glass, asbestos, carbon, cellulose, synthetic organics, natural organics, sisal, and combinations thereof.

Any of the embodiments herein may include a composition as described and claimed wherein said cement is portland cement with a calcium to silica ratio of less than about 3.1.

Any of the embodiments herein may include a composition as described and claimed wherein said silica fume is at least 96% silica with a maximum carbon content of less than about 4%.

Any of the embodiments herein may include a composition as described and claimed wherein said silica flour is crushed silica of less than about 40 microns in its longest dimension.

Any of the embodiments herein may include wherein said microinclusions include fibers having lengths between about 18 to about 38 mm and in diameters between about 0.38 to about 0.63 mm.

Any of the embodiments herein may include wherein fibers incorporate ends selected from the group consisting of: hooked ends, approximately straight ends, bulbed ends, and combinations thereof.

Any of the embodiments herein may include fibers having a surface selected from the group consisting of: silica fume bonded to said surface, glass frit bonded to said surface, a roughened surface, and combinations thereof.

Any of the embodiments herein may include a composition as described and claimed further comprising mats of steel strands of diameter less than about 2.5 mm affixed to a tensile-load carrying face of said structure.

Any of the embodiments herein may include wherein said high-range water-reducing admixture comprises polycarboxylates, wherein said amount is in the range of about three to about 20 fluid ounces per 100 lb of said resultant cement-containing paste.

Any of the embodiments herein may include wherein said microinclusions are selected from the group consisting of: fiber microinclusions, spherical microinclusions, polyhedron microinclusions, and combinations thereof.

Any of the embodiments herein may include wherein said microinclusions have a longest dimension from about one micron to about 150 microns.

Any of the embodiments herein may include wherein microinclusions are fabricated from the group consisting of: metals, ceramics, organics, natural inorganics, natural minerals, synthetics, and combinations thereof.

Any of the embodiments herein may include configurations of said microinclusion materials are selected from the group consisting of: steel shavings, ceramic whiskers, ceramic spheres, mineral fibers, wollastonite, carbon fibers and combinations thereof.

Any of the embodiments herein may include wherein said cement-containing paste is a stiff dough with approximately zero slump.

Any of the embodiments herein may include wherein said cement-containing paste is a flowable mixture.

Any of the embodiments herein may include wherein said cement-containing paste is used to manufacture components are selected from the group consisting of: plates, channels, pipes, tubes, I-sections, WF-sections, connectors, panels, and combinations thereof.

Any of the embodiments herein may include wherein said components are employed to fabricate items selected from the group consisting of: vehicle up-armoring, ballistic armor, blast-resistant panels, man-portable panels, thin armor panels, forced entry resistant structural elements, roofing tiles, wall panels, floor tiles, hurricane and tornado resistant structural elements, and combinations thereof.

In another preferred embodiment, the invention provides a method of producing a component of a structure, said structure having a combination of strength and toughness suitable to resist blast and to resist penetration by ballistic fragments, comprising: (i) Preparing a uniform cement-containing paste according to the processes herein; and (ii) Forming said resultant cement-containing paste in the shape of said component, and Optionally hydrating said formed resultant cement-containing paste.

In another preferred embodiment, the invention provides a method as described and claimed wherein said forming is done by techniques selected from the group consisting of: spin casting, extrusion molding, pressure molding, pouring into forms, and combinations thereof.

In another preferred embodiment, the invention provides a method as described and claimed wherein said composition component is cured by: (i) placing in an environment of approximately 100% relative humidity for about seven days at ambient temperature, (ii) submersing in water of approximately 85° C. to about 91° C. for about three to about five days, and (iii) heating in air at approximately 85° C. to about 91° C. for about one to about two days, wherein, said cured composition component becomes crystalline. This crystalline structure is unlike components cured under ambient conditions which create weaker amorphous calcium silicate hydrate components having lower strength of 3500 psi or lower.

In another preferred embodiment of the invention, there is provided a ultra high performance component, comprising: a form made using the composition(s) described herein, wherein the component has a strength of at least 10,000 psi.

In another preferred embodiment, the component has a strength of over 21,500 psi.

In another preferred embodiment, the component is heat cured and has a strength of over 100,000 psi.

The process for producing silicon carbide and multiwalled carbon nanotubes (MWCNTs) includes heating agricultural waste husks in an inert atmosphere to a temperature higher than 1300 degrees C. to obtain a mixture containing silicon carbide and MWCNTs, and treating the mixture to extract MWCNTs and separate the MWCNTS from the silicon carbide.

The agricultural waste husks contain over 90% silica content and are comprised of sugarcane bagasse, rice husks, or a combination of the two.

An extraction step comprises adding to the mixture a dispersant selected from Sodium Dodecyl Sulfonate (SDS), Sodium Dodecyl Benzene Sulfonate (SDBS), Tetrahydrofuran (THF), polyvinylpyrrolidone (PVP), N-methylpyrrolidone (NMP), isopropyl alcohol, or an acid, to separate the MWCNTs from silicon carbide. In other embodiments, the extraction comprises subjecting an output stream of the mixture to an electromagnetic field to separate the MWCNTs from silicon carbide, or comprises centrifuging the mixture in a density gradient matrix to separate the MWCNTs from silicon carbide. In some embodiments, the extraction comprises acid treatment, for example treating the mixture with sulfuric acid, nitric acid, hydrochloric acid, or a mixture thereof, with or without sonication, to functionalize the MWCNTs (—COOH) for dispersion without an aqueous solution, followed by separation of MWCNTs from silicon carbide by filtering and/or centrifuging, and/or treatment with a salt-forming composition such as a base.

In another non-limiting preferred embodiment, the extraction comprises performing a two step extraction of subjecting the mixture to an electromagnetic field to create a first MWCNT extraction product and a first silicon carbide extraction product, followed by separately treating the first MWCNT extraction product and the first silicon carbide extraction product with a dispersant to create second MWCNT extraction products and second silicon carbide extraction products, respectively, and combining the first and second MWCNT extraction products into a purified MWCNT product and combining the first and second silicon carbide extraction products into a purified silicon carbide product.

In another non-limiting preferred embodiment, the extraction comprises separately centrifuging the purified MWCNT product and purified silicon carbide product in a density gradient matrix, and collecting a highly purified MWCNT product and a highly purified silicon carbide product, respectively.

Any of the processes described herein may include wherein the heating step includes adding to the agricultural waste husks a silica composition selected from: crushed glass or glass frit, wherein said crushed glass or glass frit is provided at a mass ratio of about 0.75 to about 1.25 of said agricultural waste husks; sand, wherein said sand is provided at a mass ratio of about 0.75 to about 1.25 of said agricultural waste husks; silica fume, wherein said silica fume is provided at a mass ratio of about 0.15 to about 0.4 of said agricultural waste husks; silica flour, wherein said silica flour is provided at a mass ratio of about 0.15 to about 0.3 of said agricultural waste husks, and combinations thereof.

Any of the processes described herein may include wherein the inert atmosphere is a vacuum atmosphere, a nitrogen atmosphere, or an argon atmosphere.

Any of the processes described herein may include wherein the heating step includes adding an organic component selected from carbon monoxide, compounds containing C2-C18 alkyl, alkenyl, or aryl groups such as hydrocarbon gases, liquids, or oils, plastics, and plastic waste.

Any of the processes described herein may include wherein the heating step is performed in a flow reactor.

Any of the processes described herein may include wherein the heating step is performed in a flow reactor, wherein the flow reactor is a reactor vessel and a catalyst, and wherein the flow reactor includes a steel tube.

The terminology used herein is for the purpose of describing particular embodiments only and is not intended to limit the full scope of the claims. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention.

As used herein, the singular forms “a”, “an” and “the” are intended to include the plural forms as well, unless the context clearly indicates otherwise. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” etc.). Similarly, the terms “comprises” and/or “comprising,” when used in this specification, specify the presence of stated features, integers (or fractions thereof), steps, operations, elements, and/or components, but do not preclude the presence or addition of one or more other features, integers (or fractions thereof), steps, operations, elements, components, and/or groups thereof. As used in this document, the term “comprising” means “including, but not limited to.”

As used herein the term “and/or” includes any and all combinations of one or more of the associated listed items. It should be understood that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All ranges disclosed herein also encompass any and all possible subranges and combinations of subranges thereof unless expressly stated otherwise. Any listed range should be recognized as sufficiently describing and enabling the same range being broken down into at least equal subparts unless expressly stated otherwise. As will be understood by one skilled in the art, a range includes each individual member.

The embodiments herein, and/or the various features or advantageous details thereof, are explained more fully with reference to the non-limiting embodiments that are illustrated in the accompanying drawings and detailed in the following description. Descriptions of well-known components and processing techniques are omitted so as to not unnecessarily obscure the embodiments herein. Like numbers refer to like elements throughout.

The examples and/or embodiments described herein are intended merely to facilitate an understanding of structures, functions, and/or aspects of the embodiments, ways in which the embodiments may be practiced, and/or to further enable those skilled in the art to practice the embodiments herein. Similarly, methods and/or ways of using the embodiments described herein are provided by way of example only and not limitation. Specific uses described herein are not provided to the exclusion of other uses unless the context expressly states otherwise.

The term “ultra-high performance concrete” (UHPC) refers to compositions made by the processes described here, and may further include the addition of aggregate to the cement paste.

The term “SiC” refers to silicon carbide. Industrial production of SiC can be achieved by high temperature treatment of organic materials such as agricultural waste husks.

The term “MWCNT” refers to multi-walled carbon nanotubes. In a preferred non-limiting embodiment, the MWCNTs have a diameter from 20-40 nm and a length from 0.5-40 nm. Multi-walled carbon nanotubes (MWCNTs) are a special form of carbon nanotubes in which multiple single-walled carbon nanotubes are nested inside one another. MWCNTs have the unique properties that are seen within single-walled and double-walled carbon nanotubes but also have increased dispersability compared to single walled carbon nanotubes, resulting in the reduced cost in synthesis and purification of these materials.

The term “agricultural waste” refers to rice husk, sugarcane bagasse, or other silica containing agricultural waste such as waste from sorghum, peanuts, walnuts, almonds, pistachios, nut shells, map fruit pits such as from dates, peaches, mango, and corn husk materials. In a preferred embodiment, rice husks contain 90-98% silica composition, and sugarcane bagasse contains about 92% silica composition. Other waste products may require additional silica be added to the process to obtain the desired silicon carbide product, in desired ratio with the carbon nanotube containing soot product.

In some embodiments, the agricultural waste bulk starting material may require grinding or milling the agricultural waste into a fine powder. Flow agents may also be added to facilitate loading of the agricultural waste into the reaction vessel. The agricultural waste may also be pelletized with or without a binder for bulk processing.

The term “organic component” refers to the carbon component of the agricultural waste as well as any carbon containing additive that is added to the agricultural waste to include the MWCNT product. Examples of added organic components (added to the agricultural waste) include carbon monoxide, compounds containing C2-C18 alkyl, alkenyl, or aryl groups such as hydrocarbon gases, liquids, or oils, plastics, and plastic waste. Plastic waste includes polypropylene

The term “heating” refers to vacuum oven-heating, microwave heating, or flow reaction heating to achieve producing silicon carbide and MWCNT from the starting materials. In a preferred embodiment, microwave heating may be used, and may include using a 50-100 GHz beam, preferably 83 GHz, with a total beam power of 2-10 kW, preferably 5 kW.

The term “temperature” refers to temperatures and conditions that result in the conversion of the starting materials to SiC and MWCNTs. Typical ranges of temperatures for converting agricultural waste to SiC include 1300°−1900° C.

Any of the processes herein may include heating conditions that include a vacuum environment, an Argon atmosphere, a Nitrogen atmosphere, or a mixture of gases. The time for heating includes a range from 2-15 minutes, and more preferably from 6-15 minutes, and even more preferably from 8-10 minutes.

The term “purification” or “separation” refers to a process for separating the mixture product that is formed by the inventive process, and refers to one or more processes for separating the SiC product and the MWCNT product.

### Example—Purification of MWCNT

A typical purification process is as follows: 1 kg MWCNTs in 20 kgs of 20% HNO3 solution at 80-90° C. for 6 hrs, then it is repeatedly filtered, DI water washed, and filtered until the filtrate solution is PH neutral. The MWCNTs are then dried until the form a cake. It is then broken up into a fine powder. MWCNTs made from this process will form a colloidal suspension in solvents. They can be deposited on substrates, or further manipulated in solution, and can have many different functional groups attached to the MWCNTs

The term “dispersant” refers to a liquid that evenly disperse the MWCNT within the liquid matrix, with or without sonication. Examples of dispersants include Sodium Dodecyl Sulfonate (SDS), Sodium Dodecyl Benzene Sulfonate (SDBS), Tetrahydrofuran (THF), polyvinylpyrrolidone (PVP), N-methylpyrrolidone (NMP), isopropyl alcohol, sulfuric acid, nitric acid, hydrochloric acid, hydrogen peroxide, or a mixture of acids such as sulfuric and nitric acids.

The term “silica” refers to silicon dioxide. Silica fume refers to pyrogenic silica because it is produced in a flame, consists of microscopic droplets of amorphous silica fused into branched, chainlike, three-dimensional secondary particles which then agglomerate into tertiary particles. The resulting powder has an extremely low bulk density and high surface area. Silica flour refers to finely ground, nearly pure silicon dioxide.

In a preferred process, silica in the form of glass, glass frit, sand, silica fume, and/or silica flour is added to the agricultural waste.

The term “magnetic separation” refers to the use of an electro-magnetic field which is applied to a reaction stream to separate MWCNT from SiC on the basis of their inherent or functionalized magnetic properties.

The term “flow reaction tube” refers to a metal tube reaction vessel that may contain one or multiple stages, where each stage may have the same or separate atmosphere, pressure, and temperature. In a preferred embodiment, the metal tube is stainless steel in order to catalyze, using Fe and Ni, the formation of MWCNTs as soot along the inner surface within the lumen of the metal tube.

### Example—Process

Referring now to FIG. 1, FIG. 1 shows a non-limiting preferred embodiment wherein, first, the agricultural waste is milled to a powder. Silica and/or organic components are added to optimize production of SiC and MWCNTs. This starting material is added to a stainless steel tube furnace and the atmosphere is converted to a vacuum or to an argon atmosphere. The tube furnace is heated to a temperature of 1300-1900° C. for at least 10 minutes. The tube furnace is cooled and the SiC containing powder contents are removed for processing to purify the SiC and separate any remaining MWCNTs. The inner surface of the tube furnace is treated with acid and/or mechanical scraping to remove the MWCNT containing black powder. Solvents may be used to remove carbon impurities such as fullerenes. Additional processing of the MWCNT containing black powder is performed to purify the MWCNTs from the black powder.

### Example—Process with Recycled Plastic and Recycled Glass

Referring now to FIG. 2, wherein FIG. 2 shows another non-limiting preferred embodiment wherein first, the agricultural waste is milled to a powder. Recycled glass is milled to a powder and recycled plastics are shredded and/or ground to a powder. The recycled glass powder and the recycled plastic powder are added to the milled agricultural waste powder in a ratio to optimize production of SiC and MWCNTs. This starting material is added to a stainless steel tube furnace and the atmosphere is converted to a vacuum or to an argon atmosphere. The tube furnace is heated to a temperature of 1300-1900° C. for at least 10 minutes. The tube furnace is cooled and the SiC containing powder contents are removed for processing to purify the SiC and separate any remaining MWCNTs. The inner surface of the tube furnace is treated with acid and/or mechanical scraping to remove the MWCNT containing black powder. Solvents may be used to remove carbon impurities such as fullerenes. Additional processing of the MWCNT containing black powder is performed to purify the MWCNTs from the black powder.

### 90. Example—Use of Microinclusions (mwCNTs, SiC, UHMWPE) in Ultra High Performance Concrete

Referring now to FIG. 3, MWCNTs made according to the invention herein can be used in the manufacture of UHPC. In one non-limiting example, the composition and method may comprise blending a group of first constituents that are dry-blended with microinclusions, followed by mixing with a group of second constituents.

For UHPC, first constituents may comprise (i) cement of Blaine fineness of about 280 to about 360 m2/kg; (ii) sand, wherein said sand is provided at a mass ratio of about 0.75 to about 1.25 of said cement; (iii) silica fume, wherein said silica fume is provided at a mass ratio of about 0.15 to about 0.4 of said cement; (iv) silica flour, wherein said silica flour is provided at a mass ratio of about 0.15 to about 0.3 of said cement; (v) microinclusions, wherein said microinclusions are provided at a mass ratio of up to about 0.35 of said cement, and wherein said first constituents are mixed to yield a first homogeneous mix; and wherein the second constituents comprise (vi) at least one high-range water-reducing admixture; and (vii) water, wherein said water is provided at a mass ratio of about 0.2 to about 0.35 of said cement, and wherein said high-range water-reducing admixture and said water are blended into a second homogenous mix prior to mixing said second homogenous mix with said first homogeneous mix to form a uniform cement-containing paste; wherein said microinclusions are provided at a mass ratio of up to about 0.35 of said cement, and wherein said microinclusions are blended into said uniform cement-containing paste such that said microinclusions are distributed approximately uniformly in a resultant cement-containing paste, and wherein said resultant cement-containing paste is hydrated.

Surprisingly, it has been found that it is important for the microinclusions to be dry-blended with the first constituents to ensure the proper dispersion of the microinclusions within the resultant composition and to obtain homogeneity of the mixed components.

Any of the UHPC embodiments may include wherein the microinclusions can also include plasma treated recycled steel fibers, wherein the microinclusions are cleaned by plasma treatment to remove organic contamination, remove surface oxides, increase surface hydrophilic property, and improve adhesion, wherein the plasma treatment is selected from the group consisting of: Argon plasma micro-sandblasting, Hydrogen plasma treatment for removal of surface oxides on the recycled steel fibers, Helium plasma treatment, Nitrogen plasma treatment, and Oxygen plasma treatment; wherein the microinclusions are surface-modified by plasma treatment using plasma enhanced chemical vapor deposition to coat the microinclusions with one or more layers selected from the group consisting of: carbon, silicon, carbon nanotubes, silicon carbide, silicon nitride, and mixtures thereof; wherein the microinclusions are surface energy modified by plasma treatment to have one or more ultra-thin layers of a film that adjusts wetting properties to improve of the wettability and increase the mixability of the microinclusions in the composition.

Any of the UHPC embodiments may include microinclusions, wherein said microinclusions are mixed with said first constituents to yield said first homogeneous mix, including wherein said material for formation of said microinclusions are selected from the group consisting of: metals, alloys, steel, synthetics, polymers, natural inorganics, minerals, glass, asbestos, carbon, cellulose, synthetic organics, natural organics, sisal, and combinations thereof.

Any of the UHPC embodiments may include wherein said cement is portland cement with a calcium to silica ratio of less than about 3.1, wherein said silica fume is at least 96% silica with a maximum carbon content of less than about 4%, and wherein said silica flour is crushed silica of less than about 40 microns in its longest dimension.

Any of the UHPC embodiments may include wherein said microinclusions are of lengths between about 18 to about 38 mm and in diameters between about 0.38 to about 0.63 mm, wherein said microinclusions incorporate ends selected from the group consisting of: hooked ends, approximately straight ends, bulbed ends, and combinations thereof, wherein said microinclusions have a surface selected from the group consisting of: silica fume bonded to said surface, glass frit bonded to said surface, a roughened surface, and combinations thereof, and wherein may include microinclusions selected from the group consisting of: fiber microinclusions, spherical microinclusions, polyhedron microinclusions, and combinations thereof, and/or wherein said microinclusions have a longest dimension from about one micron to about 150 microns, and/or nanoinclusions that are included in said first constituents to yield said first homogeneous mix, and/or wherein said nanoinclusions are selected from the group consisting of: fiber nanoinclusions, spherical nanoinclusions, polyhedron nanoinclusions, and combinations thereof, and/or said nanoinclusions are fabricated are selected from the group consisting of: carbon nanotubes, colloids, colloidal silica, and combinations thereof, and/or said microinclusions are fabricated are selected from the group consisting of: metals, ceramics, organics, natural inorganics, natural minerals, synthetics, and combinations thereof, and/or said microinclusion materials are selected from the group consisting of: steel shavings, ceramic whiskers, ceramic spheres, mineral fibers, wollastonite, carbon fibers and combinations thereof.

Any of the UHPC embodiments may further comprising mats of steel strands of diameter less than about 2.5 mm affixed to a tensile-load carrying face of said structure.

Any of the UHPC embodiments may include wherein high-range water-reducing admixture comprises polycarboxylates, wherein said amount is in the range of about three to about 20 fluid ounces per 100 lb of said resultant cement-containing paste.

Any of the UHPC embodiments may include wherein said cement-containing paste is a stiff dough with approximately zero slump, or wherein said cement-containing paste is a flowable mixture.

Any of the UHPC embodiments may include wherein the cement structure is a component selected from the group consisting of: plates, channels, pipes, tubes, I-sections, WF-sections, connectors, panels, and combinations thereof, or wherein said component is employed to fabricate items selected from the group consisting of: vehicle up-armoring, ballistic armor, blast-resistant panels, man-portable panels, thin armor panels, forced entry resistant structural elements, roofing tiles, wall panels, floor tiles, hurricane and tornado resistant structural elements, and combinations thereof.

Any of the embodiments herein may include a method of producing a UHPC composition component of a structure, said structure having a combination of strength and toughness suitable to resist blast and to resist penetration by ballistic fragments, comprising: mixing first constituents comprising: cement of Blaine fineness of about 280 to about 360 m2/kg; sand, wherein said sand is provided at a mass ratio of about 0.75 to about 1.25 of said cement; silica fume, wherein said silica fume is provided at a mass ratio of about 0.15 to about 0.4 of said cement; silica flour, wherein said silica flour is provided at a mass ratio of about 0.15 to about 0.3 of said cement; microinclusions, wherein said microinclusions are provided at a mass ratio of up to about 0.35 of said cement, and wherein said mixing results in a first homogeneous mix; mixing second constituents comprising: at least one high-range water-reducing admixture; and water, wherein said water is provided at a mass ratio of about 0.2 to about 0.35 of said cement, and wherein said mixing of said second constituents results in a second homogenous mix; mixing said first homogeneous mix with said second homogeneous mix to form a uniform cement-containing paste; blending microinclusions into said uniform cement-containing paste such that said microinclusions are distributed approximately uniformly in a resultant cement-containing paste; forming said resultant cement-containing paste in the shape of said component, and hydrating said formed resultant cement-containing paste.

Any of the method of making UHPC forms may be made by techniques selected from the group consisting of: spin casting, extrusion molding, pressure molding, pouring into forms, and combinations thereof.

Any of the method of making UHPC forms wherein said composition component is cured by: placing in an environment of approximately 100% relative humidity for about seven days at ambient temperature, submersing in water of approximately 85° C. to about 91° C. for about three to about five days, and heating in air at approximately 85° C. to about 91° C. for about one to about two days, wherein, said cured composition component becomes crystalline unlike said composition components cured under ambient conditions as an amorphous calcium silicate hydrate.

Plasma Treatment

Any of the fibers used herein may be subject to plasma etching treatment. Plasma treatment is a surface modification technique that readily primes any surface for better acceptance of secondary manufacturing applications. Plasma is a reactive treatment process where positive and negative ions, electrons, and radicals react and collide as long as an electric potential difference exists. Some plasma treatments use low pressure, or vacuum plasma, for more consistent and longer-lasting surface treatments. By plasma treating fibers, the invention provides microscopically changed surfaces for improved bonding, micro-cleaned fibers to enhance the surface wetting of adhesives or over-molded elastomers, functionalized groups (carbonyl, hydroxyl and others) to improve surface energy, and the establishment of hydrophobic and hydrophilic properties.

Plasma Cleaning

Plasma cleaned fibers avoids the use of environmentally unfriendly cleaning chemicals in addition to e.g. trichloroethylene. Plasma cleaning offers significant advantages over wet cleaning methods alone and removes organic contamination, renders surfaces more hydrophilic, and improves adhesion.

Argon plasma micro-sandblasting is contemplated as a plasma treatment herein.

Hydrogen plasma plasma treatment is also contemplated for removal of surface oxides on the recycled steel fibers. Helium, Nitrogen, and Oxygen plasma treatments are included within the scope of the invention.

Plasma CVD Surface Modification

Functionalized groups can be added to the cleaned surface of the fibers using plasma enhanced chemical vapor deposition to coat the fibers with layers of carbon, silicon, carbon nanotubes, silicon carbide, silicon nitride, and so forth.

Plasma Wetting Layer

Improving wettability of the fibers is also an aspect of plasma treatment included herein.

Use of plasma treatment to modify the surface energy of the surface of the fibers increases the mixability of the fibers in the composition. Examples of modifying the surface energy includes deposition of ultra-thin layers by plasma to adjust wetting properties, using siloxane-based or fluorocarbon films.

Composition Toughness

In select embodiments of the present invention, structures and components are built using a superior composition, providing a combination of high strength and superior energy absorbing capacity. Toughness is a measure of the amount of energy required to be expended to open cracks in the matrix under tensile loading. It is an important metric for objects that suffer impact.

Select embodiments of the present invention provide formulations and methods of fabrication for producing an optimum combination of increased strength and toughness in a custom composition that may be formulated with plasma treated fibers.

Consistency Modifiers

Select embodiments of the present invention may incorporate high-performance materials such as woven mats of small diameter high-strength wire comprising steel or synthetics such as carbon fiber, fiberglass, and aramids, to further enhance performance. In select embodiments of the present invention, un-hydrated cement-based paste may be mixed in a “dough-like” consistency enabling it to be extrusion molded, spun-cast, or formed under external pressure into shapes suitable for protective applications, such as components for improving blast resistance of structures, for fabricating inexpensive alternatives to ceramic armor, and the like. This stiff mixture holds its shape during production and curing without the need of formwork, enabling it to be produced on an assembly line.

Because of superior performance, select embodiments of the present invention are suitable for commercial use as structural members and resistant panels. Select embodiments of the present invention obtain superior strength and toughness qualities through, among other considerations, proper selection of the type and quantity of constituents, including macro-, micro- and nano-sized inclusions of specified composition.

Macro- and microfiber reinforcement contributes to an optimum combination of strength and toughness. Macro-fibers address bridging of macro-cracks and micro-fibers address bridging of micro-cracks.

### Example—Specific Mixtures

Initial mixes of select embodiments of the present invention comprise: a cement of Blaine fineness at about 280 to about 360 m2/kg; sand at a mass ratio of about 0.75 to about 1.25 of the mass of cement; silica fume at a mass ratio of about 0.15 to about 0.4 of the mass of cement; silica flour at a mass ratio of about 0.15 to about 0.3 of the mass of cement; at least one high-range water-reducing admixture (HRWRA), such as GLENIUM® 3030 NS, Degussa Admixtures, Inc.; ADVA® 170 and ADVACAST® 500, W R. Grace & Co., and PLASTOL, EUCON 37 and EUCON 1037, Euclid Chemical Co., in amounts approximately commensurate with the recommendations of the manufacturer; plasma treated fibers.

Optional Additional Fibers

Besides carbon nanotube fibers, optional additional fibers include mineral fibers (e.g., glass or asbestos), optional synthetic organic fibers (e.g., carbon, cellulose, or polymeric), optional natural organic fibers (e.g., sisal) at a mass ratio of up to about 0.35 of the mass of cement; and water at a mass ratio of about 0.2 to about 0.35 of the mass of cement.

In select embodiments of the present invention, an HRWRA may be added in specified amounts of about 3-20 fluid ounces per 100 lbs of the cement-based paste.

### Example—Mix Variations

For select embodiments of the present composition, constituents may vary within the initial mix. For example, the cement may be portland cement of high-silica content, i.e., a calcium to silica ratio (Ca/Si) of less than about 3.1. Silica fume may be incorporated, of preferably at least 96% silica with a carbon content of less than about 4%. Silica flour may be incorporated, preferably as pure, finely crushed silica of less than about 40 microns. microinclusions consist of plasma treated fibers.

The composition may also contain optional synthetic fibers, polymer fibers, organic fibers, natural inorganic fibers, and the like, and combinations thereof.

Microinclusion Size

Preferably, microinclusions are provided in lengths between about 18 to about 38 mm (0.75-1.5 in.) and in diameters between about 0.38 to about 0.63 mm (0.015-0.025 in.). The ends of the microinclusions may be hooked, straight, or “bulbed.” Special treatment of the microinclusions, such as bonding silica fume or glass frit to the surface or roughening the surface, enhances the bond between the cement-based paste and the microinclusions.

Mats comprising continuous, high-strength steel strands of diameter less than about 2.5 mm (0.1 in.) may be embedded in or bonded to the tensile-load carrying face of the mix to add strength and toughness. The high-range water-reducing admixture (HRWRA) may be a polycarboxylate type material, added in amounts approximating recommendations of the manufacturer.

Inclusions

In select embodiments of the present invention, microinclusions, also termed dispersions, are incorporated to increase the toughness of the mix (cement-based paste) at the micro (or nano) scale by acting as micro-crack bridging mechanisms that truncate or delay the growth of micro cracks in the mix and at the nanoscale by filling the void spaces between larger particles making the material more dense.

Microinclusions may be selected from the group comprising: fiber-like microinclusions, spherical microinclusions, polyhedron microinclusions, fiber-like nanoinclusions, spherical nanoinclusions, polyhedron nanoinclusions, and the like, and combinations thereof. In select embodiments of the present invention, microinclusions may have a longest dimension from about one micron to about 150 microns.

Microinclusions may be selected from the group of materials comprising: metals, ceramics, organics, natural minerals, and the like, and combinations thereof. Specific configurations of these microinclusion materials may be selected from the group comprising: steel shavings, ceramic whiskers, ceramic spheres, mineral fibers, wollastonite, carbon fibers, carbon nanotubes, and the like, and combinations thereof. Further, microinclusions may be selected from the class of materials of a colloidal nature such as colloidal silica.

Flow Modifiers

In select embodiments of the present invention, the rheology of the constituents in the mix may range from highly flowable to that of stiff dough or clay, depending on the concentration of each of the constituents. The rheology of a particular mix is dependent on the volume and surface area of dry constituents (including the microinclusions and select nanoinclusions), the volume of water, and the mass of the HRWRA used. For example, a stiff dough-like mixture suitable for extruding or spin-casting contains a relatively high volume of dry constituents, a relatively low volume of water and a relatively moderate to low mass of an HRWRA. Conversely, a flowable mixture contains a relatively low volume of dry constituents, a relatively high volume of water and a relatively high mass of an HRWRA.

For mixing select embodiments of the present invention, equipment for making “stiff” mixtures comprises a shear-type mixer, such as a paddle or star-wheel mixer. These impart high-shear energy to the wetted constituents, readily converting them into a cement-based paste, albeit a stiff paste. The greater the shear-imparting energy imparted to the constituents in mixing, the quicker they form into a cement-based paste.

For mixing select embodiments of the present invention, equipment for making “flowable” mixtures may be conventional drum-type mixers or the above high-shear mixers.

### Example—Blending Process

In select embodiments of the present invention, the process comprises loading dry constituents, including microinclusions, such as microfibers and nanofibers, into the bowl of the mixer and first blending them in the dry state for about ten minutes. The HRWRA and water, and optionally, any colloidal nanoinclusions, are blended separately from the dry constituents and then added to the dry ingredients as the mixer is operating. Mixing continues to yield a homogeneous cement-based paste. In select embodiments of the present invention, the wet mixing may consume an hour depending on the amount of shear energy being imparted to the mixture and the volume of water and mass of the HRWRA added to wet the dry constituents. The mixture becomes a “homogenized” paste when no more individual particles are visible and the components in the mixer have come together as a single mass of cement-based paste having no separately distinguishable components. At this point, for select embodiments of the present invention, microinclusions may be added and blended for ten minutes to allow them to distribute evenly.

### Example—Molds and Forms

In select embodiments of the present invention, the cement-based paste is placed in molds to hydrate (harden). In select embodiments of the present invention, the molding procedure depends on the rheology of the final cement-based paste. Flowable cement-based pastes are placed or poured into molds that contain the cement-based paste until it hydrates.

In select embodiments of the present invention, fluid cement-based paste may be vibrated by placing molds filled with cement-based paste on an external vibrating table and vibrating the mold and cement-based paste as a unit, or by inserting internal vibrators into the cement-based paste and vibrating until it is consolidated. Vibration frees entrapped air voids from the cement-based paste and consolidates solid constituents into a tightly packed configuration.

In select embodiments of the present invention, “stiff” mixtures of the cement-based paste are shaped by pressure molding, extrusion molding, or spin casting. In select embodiments of the present invention, pressure molding comprises rolling or pressing a dough-like cement-based paste into a prepared mold or pressing a dough-like cement-based paste to a given thickness as in the case of making plates or tiles. In select embodiments of the present invention, placing a dough-like cement-based paste into an extruder and applying pressure to force it through the die yields a final molded shape. Extruded product may need to be supported until it hardens to prevent it from changing shape. In select embodiments of the present invention, spin casting involves placing a dough-like cement-based paste along the longitudinal axis of the inside of a mold and spinning the mold at high speed to distribute the cement-based paste evenly over the inside of the mold with the centrifugal force created by the spinning.

In select embodiments of the present invention, the molded, extruded or spun-cast cement-based paste is left in the mold or supported in the extruded or spun-cast shape until it has hydrated. This is normally 24 hours, but may be longer depending on the amount of the HRWRA specified for the formulation. In select embodiments of the present invention, product is not removed from the mold until it has achieved a stiffness that resists deformation under moderate force, such as thumb pressure.

### Example—Curing

In select embodiments of the present invention, curing may be done by conventional methods such as water curing or by applying a curing compound for the same length of time as conventional cement-based paste is cured. However, conventional curing methods may not yield an optimum combination of strength and toughness. To achieve a desired combination, in select embodiments of the present invention, the hydrated but not fully cured, cement-based paste is heated. In select embodiments of the present invention, prior to heating, the cement-based paste is cured for about seven days in an environment of approximately 100% relative humidity at ambient temperature, approximately 21° C.±3° C. (70° F.±5° F.), submersed in water at approximately 88° C.±3° C. (190° F.±5° F.) for about three to about five days, and heated in air at approximately 88° C.±3° C. (190° F.±5° F.) for about one to about two days. This process configures amorphous calcium silicate hydrate as a structure that is more like a crystalline structure than the original amorphous calcium silicate hydrate.

As shown, select embodiments of the present invention provide a composition that is both strong and tough for fabricating superior building components. These superior components may be made in any shape through form casting while conventional structural shapes may be made by either mold extrusion or spin-casting.

### Example—Use as Armor

Select embodiments of the present invention are suitable for fabricating inexpensive structural panels, such as thin armor panels that may be used for vehicles as well as fixed structures. Structural armor panels may be formed or extruded to a thickness heretofore impractical because of the improved toughness and strength of embodiments of the present invention. For example, panels may be produced in size and thickness to accommodate man-portability. These man-portable panels may be configured for attaching to a structural framework to resist penetration of small arms fire and mitigate blast and fragmentation effects.

An embodiment of the present invention, configured appropriately, offers an inexpensive solution for force protection in addition to man-portable products. For the military and government applications: very high performance composition incorporated in inexpensive ballistic armor; light weight structural shapes such as plates, channels, pipes, tubes, I- and WF-sections; connectors; protective construction; blast-resistant panels; fragmenting munitions protection; vehicle up-armoring; forced entry resistant structural elements and the like.

### Example—Commercial Construction

For commercial users: building construction products, such as roofing tiles, wall panels, floor tiles, and the like; lightweight structural shapes such as plates, channels, pipes, tubes, I- and WF-sections; hurricane and tornado resistant structural elements, forced entry resistant structural elements, and the like.

Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above.

Where schematics and/or embodiments described above indicate certain components arranged in certain orientations or positions, the arrangement of components may be modified. While the embodiments have been particularly shown and described, it will be understood that various changes in form and details may be made. Any portion of the apparatus and/or methods described herein may be combined in any combination, except mutually exclusive combinations.

The embodiments described herein can include various combinations and/or sub-combinations of the functions, components, and/or features of the different embodiments described. Various of the above-disclosed and other features and functions, or alternatives thereof, may be combined into many other different systems or applications. Various presently unforeseen or unanticipated alternatives, modifications, variations, or improvements therein may be subsequently made by those skilled in the art, each of which is also intended to be encompassed by the disclosed embodiments.

It is therefore to be understood that within the scope of the appended claims, the invention may be practiced otherwise than as described. Accordingly, all such modifications are intended to be included within the scope of this invention as defined in the following claims.

1. A process, comprising (i) mixing microinclusions into a dry mixture of first constituents to yield a first homogeneous mix, the microinclusions selected from the group consisting of silicon carbide, ultra-high molecular weight polyethylene fibers, and multi-walled carbon nanotubes, the first constituents, comprising: cement of Blaine fineness of about 280 to about 360 m2/kg; sand, wherein said sand is provided at a mass ratio of about 0.75 to about 1.25 of said cement; silica fume, wherein said silica fume is provided at a mass ratio of about 0.15 to about 0.4 of said cement; silica flour, wherein said silica flour is provided at a mass ratio of about 0.15 to about 0.3 of said cement; wherein said microinclusions are provided at a mass ratio of up to about 0.35 of said cement.

2. The process of claim 1, comprising:
(ii) adding second constituents to the first homogeneous mix, said second constituents comprising at least one high-range water-reducing admixture; and water, wherein said water is provided at a mass ratio of about 0.2 to about 0.35 of said cement, and wherein said high-range water-reducing admixture and said water are blended into a second homogenous mix prior to mixing said second homogenous mix with said first homogeneous mix to form a uniform cement-containing paste.

3. A composition, comprising the first homogeneous mix of claim 1.

4. A composition comprising the uniform cement-containing paste of claim 2.

5. The process of claim 1, wherein the microinclusions are plasma-treated before mixing.

6. The process of claim 1, wherein the silicon carbide and the multiwalled carbon nanotubes are obtained by heating agricultural waste husks in an inert atmosphere to a temperature higher than 1300 degrees C. to obtain a mixture containing silicon carbide and MWCNTs.

7. The process of claim 6, wherein the mixture containing silicon carbide and MWCNTs is treated to extract MWCNTs and separate the MWCNTs from the silicon carbide.

8. The process of claim 7, comprising plasma treating the MWCNTs and plasma treating the silicon carbide.

9. The process of claim 1, comprising adding plasma-treated steel microfibers to the dry mixture of first constituents.

10. The process of claim 5, wherein plasma treated is selected from plasma cleaning, plasma surface-modification, or plasma surface-energy modification.

11. The process of claim 10, wherein plasma cleaning comprises removal of organic contamination and surface oxides, increase of surface hydrophilic property, and improvement of adhesion, wherein the plasma treatment is selected from the group consisting of: Argon plasma micro-sandblasting, Hydrogen plasma treatment for removal of surface oxides on the recycled steel fibers, Helium plasma treatment, Nitrogen plasma treatment, and Oxygen plasma treatment.

12. The process of claim 10, wherein plasma surface-modification uses plasma enhanced chemical vapor deposition to coat the microinclusions with one or more layers selected from the group consisting of: carbon, silicon, carbon nanotubes, silicon carbide, silicon nitride, and mixtures thereof.

13. The process of claim 10, wherein plasma surface energy modification creates one or more ultra-thin layers of a film that adjusts wetting properties to improve the wettability and increase the mixability of the microinclusions in the composition.

14. The process of claim 1, wherein said cement is portland cement with a calcium to silica ratio of less than about 3.1.

15. The process of claim 1, wherein said silica fume is at least 96% silica with a maximum carbon content of less than about 4%.

16. The process of claim 1, wherein said silica flour is crushed silica of less than about 40 microns in its longest dimension.

17. The process of claim 1, wherein said microinclusions include fibers having lengths between about 18 to about 38 mm and in diameters between about 0.38 to about 0.63 mm.

18. The process of claim 17, wherein fibers incorporate ends selected from the group consisting of: hooked ends, approximately straight ends, bulbed ends, and combinations thereof.

19. The process of claim 17, wherein said fibers having a surface selected from the group consisting of: silica fume bonded to said surface, glass frit bonded to said surface, a roughened surface, and combinations thereof.

20. The process of claim 2 wherein said high-range water-reducing admixture comprises polycarboxylates, wherein said amount is in the range of about three to about 20 fluid ounces per 100 lb of said resultant cement-containing paste, wherein said microinclusions are selected from the group consisting of: fiber microinclusions, spherical microinclusions, polyhedron microinclusions, and combinations thereof, wherein said microinclusions have a longest dimension from about one micron to about 150 microns.

21. The process of claim 2, wherein said cement-containing paste is a stiff dough with approximately zero slump.

22. The process of claim 2, wherein said cement-containing paste is a flowable mixture.

23. The composition of claim 4, further comprising mats of steel strands of diameter less than about 2.5 mm affixed to a tensile-load carrying face of said structure.

24. The process of claim 2, comprising forming said cement-containing paste into a component selected from the group consisting of: plates, channels, pipes, tubes, I-sections, WF-sections, connectors, panels, and combinations thereof.

25. A component made according to the process of claim 24.

26. The process of claim 2, comprising fabricating an item using said cement-containing paste wherein said item is selected from the group consisting of: vehicle up-armoring, ballistic armor, blast-resistant panels, man-portable panels, thin armor panels, forced entry resistant structural elements, roofing tiles, wall panels, floor tiles, hurricane and tornado resistant structural elements, and combinations thereof.

27. The process of claim 2, comprising (ii) Forming said resultant cement-containing paste in the shape of a component, and Optionally hydrating said component formed from said cement-containing paste.

28. The process of claim 27, wherein said forming is done by techniques selected from the group consisting of: spin casting, extrusion molding, pressure molding, pouring into forms, and combinations thereof.

29. The process of claim 27, comprising curing said component by: (i) placing in an environment of approximately 100% relative humidity for about seven days at ambient temperature, (ii) submersing in water of approximately 85° C. to about 91° C. for about three to about five days, and (iii) heating in air at approximately 85° C. to about 91° C. for about one to about two days, wherein, said cured composition component becomes crystalline and has a compressive strength of over 100,000 psi.

30. The process of claim 27, wherein the component has a compressive strength of at least 10,000 psi.

31. The process method of claim 27, wherein the component has a compressive strength of over 21,500 psi.

32. A heat-cured component made according to the process method of claim 27.

33. (canceled)

34. (canceled)

35. (canceled)

36. The process of claim 1, wherein said silicon carbide and multiwalled carbon nanotubes (MWCNTs) are obtained by the steps, comprising:
(i) heating agricultural waste husks in an inert atmosphere to a temperature higher than 1300 degrees C. to obtain a mixture containing silicon carbide and MWCNTs, and
wherein the heating step includes adding to the agricultural waste husks a silica composition selected from: crushed glass or glass frit, wherein said crushed glass or glass frit is provided at a mass ratio of about 0.75 to about 1.25 of said agricultural waste husks; sand, wherein said sand is provided at a mass ratio of about 0.75 to about 1.25 of said agricultural waste husks; silica fume, wherein said silica fume is provided at a mass ratio of about 0.15 to about 0.4 of said agricultural waste husks; silica flour, wherein said silica flour is provided at a mass ratio of about 0.15 to about 0.3 of said agricultural waste husks, and combinations thereof,
wherein the inert atmosphere is a vacuum atmosphere, a nitrogen atmosphere, or an argon atmosphere,
wherein the heating step includes adding an organic component selected from carbon monoxide, compounds containing C2-C18 alkyl, alkenyl, or aryl groups such as hydrocarbon gases, liquids, or oils, plastics, and plastic waste,
wherein the heating step is performed in a flow reactor, wherein the flow reactor is a reactor vessel and a catalyst, and wherein the flow reactor includes a steel tube,
(ii) treating the mixture to extract MWCNTs and separate the MWCNTS from the silicon carbide
wherein extracting comprises performing a two step extraction of subjecting the mixture to an electromagnetic field to create a first MWCNT extraction product and a first silicon carbide extraction product, followed by separately treating the first MWCNT extraction product and the first silicon carbide extraction product with a dispersant to create second MWCNT extraction products and second silicon carbide extraction products, respectively, and combining the first and second MWCNT extraction products into a purified MWCNT product and combining the first and second silicon carbide extraction products into a purified silicon carbide product, and
separately centrifuging the purified MWCNT product and purified silicon carbide product in a density gradient matrix, and collecting a highly purified MWCNT product and a highly purified silicon carbide product, respectively.
